(19) United States
(12) Patent Application Publication
(10) Pub. No.: US 2013/0252043 A1
(43) Pub. Date: Sep. 26, 2013

(54) System and Method for Controlling Humidity in a Battery Module

(71) Applicant: Chad Jeromy Allison, South Lyon, MI (US)

(72) Inventor: Chad Jeromy Allison, South Lyon, MI (US)

(73) Assignee: A123 SYSTEMS, INC., Waltham, MA (US)

(21) Appl. No.: 13/578,878

(22) PCT Filed: Dec. 14, 2010
(86) PCT No.: PCT/US10/60332

§ 371 Date: Aug. 14, 2012

(51) Int. Cl. H01M 10/42

(52) U.S. Cl. CPC H01M 10/42
USPC 429/72; 429/96; 29/623.2

(57) ABSTRACT

A method for reducing moisture in a battery enclosure is presented. The method may reduce battery degradation during some conditions. In one example, moisture is controlled in a battery enclosure by a desiccant material. In another example, moisture is controlled in a battery enclosure by periodically passing electrical current through a Peltier device.

### TECHNICAL FIELD

The present application relates to the field of battery environment management.

### BACKGROUND AND SUMMARY

To meet increasing power density requirements and environmental constraints manufacturers have recently adopted new compounds for batteries. For example, some batteries contain may contain compounds such as LiCoO₂ and LiMn₂O₄. These compounds may provide high voltage relative to weight. Further, such compounds may be formed into individual battery cells that may be combined to form a battery module. By assimilating a number of battery cells into a module, a high voltage, high capacity energy storage device may be formed. One application for a high voltage, high capacity battery is in a vehicle application in order to extend the vehicle range of the automobile while meeting mass requirements.

However, when some battery compound formulations are exposed to humidity their performance may degrade. In particular, water molecules in air surrounding a battery cell may react with the compound and reduce the effectiveness of electrolytic material in the battery cell. One way to reduce the possibility of battery cell degradation is to hermetically seal each battery cell so that there is less possibility of the electrolytic material being exposed to humidity. The hermetic seal serves as a barrier to humidity that may enter a battery case in which the battery cells are assembled. Nevertheless, under some conditions, it is possible for hermetic seals, as applied to battery cells, to degrade over time. For example, when a battery is applied to a vehicle application it may be exposed to vibration, changes in pressure, and changes in temperature. Accordingly, it may be possible for hermetically sealed battery cells to degrade as a result of such conditions.

The inventor herein has developed a system for controlling humidity within a battery enclosure. Specifically, the inventor has developed a system for controlling humidity of a battery enclosure, comprising: at least one battery cell; an enclosure containing said at least one battery cell; and a desiccant device removably attached to said enclosure.

By controlling humidity of a battery enclosure with a removably attached desiccant device, it may be possible to reduce degradation of battery cells contained within the battery enclosure over the life of the battery. For example, when a removable desiccant cartridge is placed in communication with the interior of a battery enclosure (e.g., by screwing-in or clipping-in a desiccant cartridge to the battery cell), moisture in the enclosure may be attracted to the desiccant rather than to battery cells, where the removably attached desiccant device can then be periodically replaced. Further, the desiccant cartridge may include a seal to further reduce ambient air from entering the battery cell. As a result, battery cell life and performance may be improved over battery enclosures that have no humidity control.

In another example, the inventor has developed an active system for controlling humidity in a battery enclosure. In particular, the inventor has developed a system for controlling humidity of a battery module, comprising: at least one battery cell; an enclosure containing said at least one battery cell; and a Peltier device in communication with said enclosure.

When water vapor is contained in a gas such as air, water may be extracted from the gas by cooling the gas to the dew point. At the dew point, water vapor condenses to liquid so that the water may be collected and disposed of. By placing a Peltier device, which acts as a heat pump between two surfaces when a current is applied, in a battery enclosure, water vapor can be extracted from the battery enclosure when a current is passed through the Peltier device. Thus, by passing current through a Peltier device, water vapor can be extracted from a battery enclosure. Further, in another example, if a cell voltage of a battery rises above a desired voltage, the excess charge can be supplied to the Peltier device so that useful work is performed by discharging the cell rather than simply generating additional heat within the battery enclosure.

The present description may provide several advantages. Specifically, the approach may reduce degradation and increase life of battery cells. Further, the approach may be a more cost effective way to remove moisture from a battery enclosure as compared to other methods.

The above advantages and other advantages, and features of the present description will be readily apparent from the following Detailed Description when taken alone or in connection with the accompanying drawings.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows a schematic view of an exemplary battery cell;

FIG. 2 shows a schematic view of an exemplary assembly of a battery cell stack;

FIG. 3 shows a schematic cross section view of one example of a desiccant cartridge positioned for attachment to a battery enclosure;

FIG. 4 shows a schematic cross section view of one example of a battery enclosure having a desiccant cartridge attached thereto;

FIG. 5 shows a schematic cut-away view of a cooling circuit for a battery cell stack;

FIG. 6 shows a schematic cross section of an alternative example of a battery enclosure having a desiccant cartridge attached thereto;

FIG. 7 shows one example of a Peltier humidity control device applied to a battery enclosure;

FIG. 8 shows an alternate example of a Peltier humidity control device applied to a battery enclosure;

FIG. 9 shows a non-limiting application of the present system and method;

FIG. 10 is a flow chart for a method to install a desiccant device to a battery enclosure; and

FIG. 11 is a flow chart for a method to control a Peltier humidity control device in a battery enclosure.

### DETAILED DESCRIPTION OF THE DEPICTED EXAMPLES

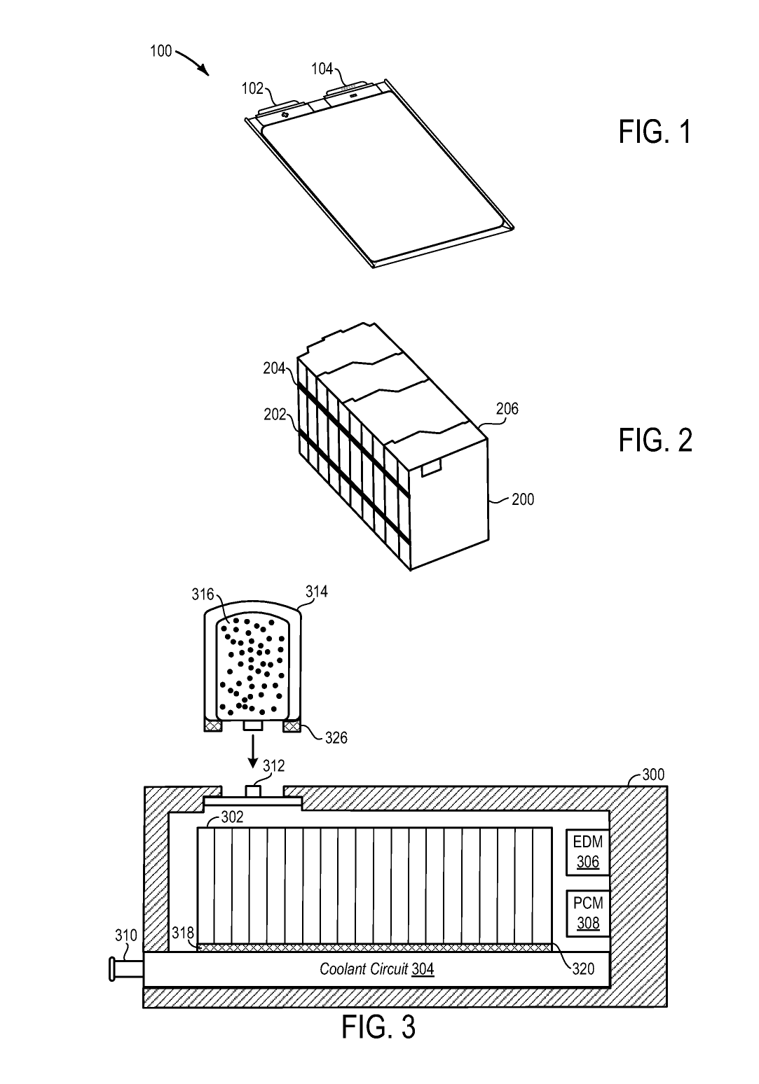

FIG. 1 shows an exemplary example of a battery cell. Battery cell 100 includes cathode 102 and anode 104 for connecting to a bus (not shown). The bus can route charge from a plurality of battery plates to output terminals of a battery pack.

Referring now to FIG. 2, an exemplary assembly of a battery cell stack is shown. Battery stack 200 is comprised of a plurality of battery cells. The battery cells are strapped together by bands 202 and 204. Cover 206 provides protection for battery bus bars (not shown) that route charge from the plurality of battery cells to output terminals of a battery pack.

Referring now to FIG. 3, battery pack 300 contains battery cell stack 302, coolant circuit 304, electrical distribution module (EDM) 306, and battery control module (BCM) 308. Coolant enters the coolant circuit at coolant connector 310. Coolant circuit 304 is in thermal communication with battery cell stack 302 via conductive grease 318 and a cold plate 320 that attaches to the individual battery cells. When heat is generated by cell stack 302, coolant circuit 304 transfers the heat to a location outside of battery pack 300. In one example, coolant circuit 304 may be in communication with a vehicle radiator. EDM 306 controls the distribution of power from the battery pack to the load. BCM 308 controls ancillary modules such at the EDM and cell monitor and balance boards (MBB). The BCM may be comprised of a microprocessor having random access memory, read only memory, input ports, and output ports. Further, in some examples the BCM may have onboard sensors for determining humidity, temperature, and/or pressure in the battery enclosure.

Mounting flange 312 includes a threaded post for screwing desiccant cartridge thereto. The threaded post is hollow and allows gases to flow from battery enclosure 300 to cartridge 314. Further, a seal 326 may be placed between mounting flange 312 and battery enclosure for reducing the migration of ambient atmospheric air into battery enclosure 300. For example, seal 326 may be a hermetic seal.

Desiccant cartridge 314 includes desiccant material 316 for attracting water vapor from battery enclosure 300 when cartridge 314 is attached to enclosure 300. In one example, a mesh of metal or plastic may be placed in cartridge 314 for retaining desiccant material in cartridge 314. The cartridge performs a dehumidification function by attracting stray water vapor that may accumulate in battery enclosure 300.

It should be noted that desiccant cartridges illustrated in FIG. 3-5 are non-limiting and may be substituted for other designs without deviating from the scope of the present description. For example, a snap-in cartridge may be substituted in place of the screw-in attachment. Further, a desiccant cartridge may be encased in the battery enclosure. In such applications, the cartridge may not be replaceable without opening the battery enclosure.

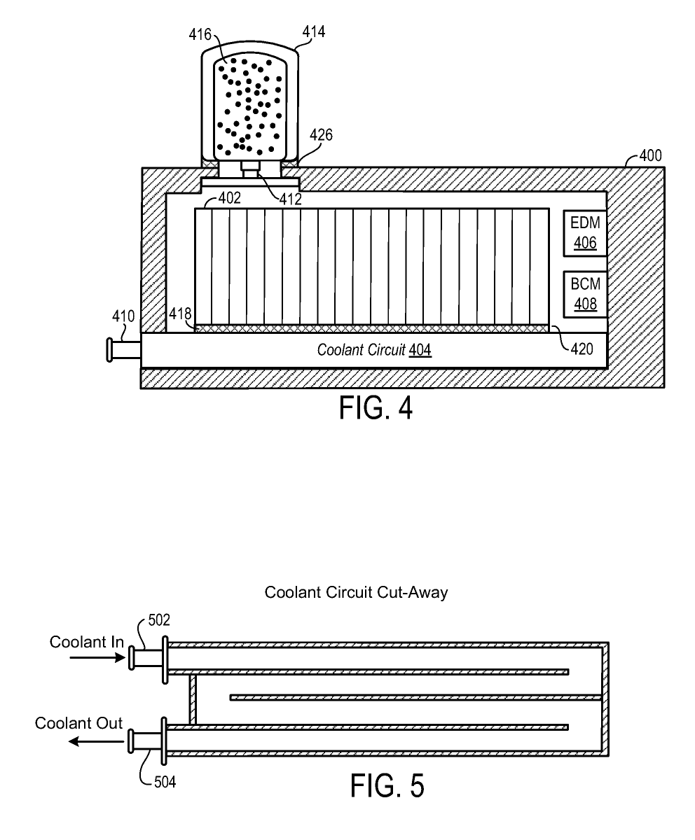

Referring now to FIG. 4, battery pack 400 is shown with disposable desiccant cartridge 414 coupled thereto. Battery pack 400 is identical to battery pack 300 of FIG. 3 except desiccant cartridge 414 is shown in communication with battery pack 400. Accordingly, battery pack 400 includes battery cell stack 402, coolant circuit 404, EDM 406, BCM 408, conductive grease 418, cold plate 420, coolant connector 410, mounting flange 412, and seal 426. These components perform functions that are identical to the components described in FIG. 3. FIG. 4 illustrates how the surfaces of enclosure 400 and desiccant cartridge contact when assembled. Specifically, mounting flange 412 provides a path between enclosure 400 and desiccant material 416 for absorbing water vapor. This configuration, like the configuration of FIG. 3 allows the contents of the cartridge to be exposed to the interior of the battery enclosure when the cartridge is installed to the enclosure.

It should be noted that the cartridge may vary in volume depending on the volume of desired water storage. In one example, the canister may be sized to hold more than 0.1 grams of water.

Referring now to FIG. 5, a cut-away of the battery pack cooling circuit is shown. Coolant flows into the upper connector 502, conducts heat from the battery pack, and exits the battery pack though the lower connector 504. If desired, a coolant flow control valve may be placed at the inlet or outlet of the coolant circuit to control the temperature of the battery pack and coolant circuit. In one example, the BCM controls the position of a flow control valve in response to a temperature sensor. In this way, it is possible to control the temperature of the battery pack to a desired temperature.

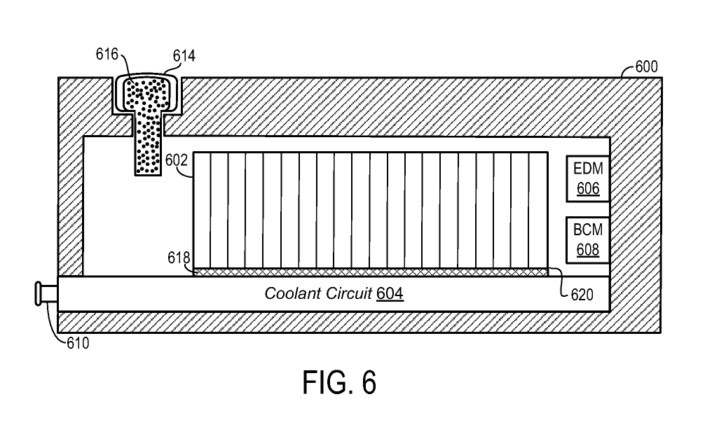

Referring now to FIG. 6, an alternative example of a desiccant dehumidifier is shown. In this example, battery pack 600 is identical to battery packs 300 and 400 of FIG. 3-4, except enclosure 600 has in inclusion that encloses a substantial portion of desiccant cartridge 614. Accordingly, battery pack 600 includes battery cell stack 602, coolant circuit 604, EDM 606, BCM 608, conductive grease 618, cold plate 620, and coolant connector 610. This example provides an added advantage that the enclosure has no external appendages. As such, this design may allow more efficient storage and mounting of battery packs. Similar to other designs, desiccant material 616 is in communication with the interior or enclosure 600 and attracts water vapor that may enter enclosure 600. In this example, desiccant cartridge 614 may be periodically replaced by unscrewing or unclamping desiccant cartridge 614 from enclosure 600.

Thus, the systems of FIGS. 3, 4, and 6 provide for a system for controlling humidity of a battery module, comprising: at least one battery cell; an enclosure containing said at least one battery cell; and a desiccant device, said desiccant device removably attached to said enclosure. The system includes wherein said enclosure includes an inclusion, said inclusion capable of enclosing a substantial portion of said desiccant. The system includes wherein said desiccant device is a disposable cartridge. The system includes wherein cartridge includes a seal for reducing air flow from atmosphere to inside said enclosure or said cartridge. The system includes wherein a content of said cartridge is exposed to an interior of said enclosure when said cartridge is installed to said enclosure. The system includes wherein said desiccant device protrudes from said enclosure. The system includes wherein said disposable cartridge is sized to hold more than 0.1 grams of water.

Further, the systems of FIGS. 3, 4, and 6 provide a system for controlling humidity of a battery module, comprising: at least one battery cell; a cold plate for removing heat from said at least one battery cell; a coolant circuit for removing heat from said cold plate and transferring said heat to a radiator of an automobile; an enclosure containing said at least one battery cell, said cold plate, and said coolant circuit; and a desiccant device, said desiccant device removably attachable to said enclosure. The system includes wherein said enclosure includes an inclusion, said inclusion capable of holding a substantial portion of said desiccant device such that a protrusion of said desiccant device from said enclosure is reduced. The system includes wherein said at least one battery cell is a plurality of battery cells. The system includes wherein said plurality of battery cells are strapped together. The system further comprises a humidity sensor for indicating when to change said desiccant device. The system includes wherein said desiccant device includes a hygroscopic material.

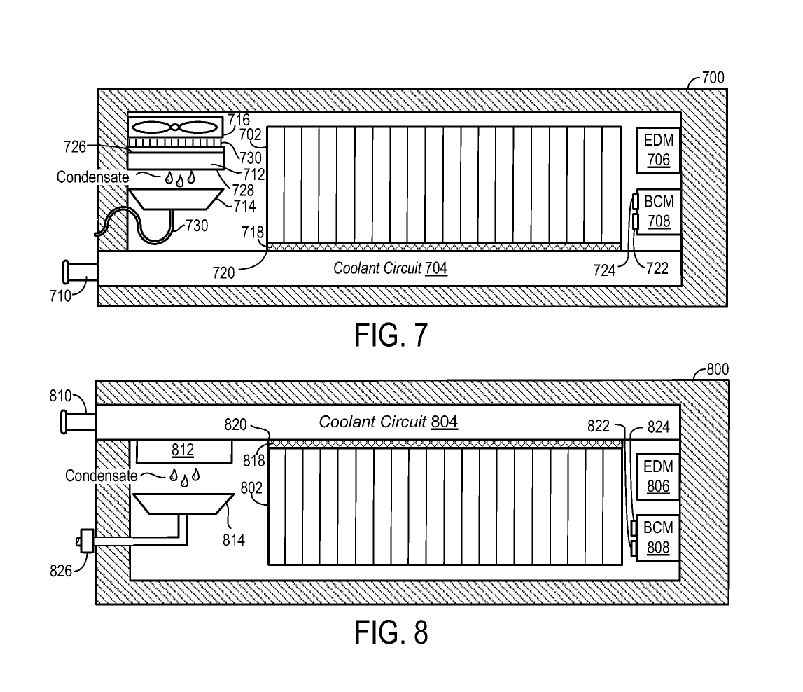

Referring now to FIG. 7, one example of a Peltier humidity control device applied to a battery enclosure is shown. Battery pack enclosure 700 includes battery cell stack 702, coolant circuit 704, EDM 706, BCM 708, conductive grease 718, cold plate 720, and coolant connector 710. Peltier device 712 has two surfaces 726 and 728. When current is passed through Peltier device 712, surface 726 is warmed and surface 728 is cooled. In one example, it is desirable to orient Peltier device 712 such that gravity will cause condensed water vapor to drip from the cooled Peltier surface to a containment device 714. Further, containment device 714 may exit battery enclosure 700 by way of an S-pipe 730 so that air from outside enclosure 700 is impeded from entering battery enclosure 700 by condensed water. In other examples, a check valve may be positioned between containment device and the environment external battery enclosure 700. In these ways, it is possible to discharge accumulated water from within enclosure 700 without allowing external air into battery enclosure 700.

Fan 716 is provided so that surface 728 may reach cooler temperatures. In particular, fan 716 rejects heat from heat sink 730 so that surface 728 may cool more. In one example, BCM may turn fan 716 on and off depending on temperature conditions within the battery enclosure and based on the dew point temperature within battery enclosure 700. For example, if the battery enclosure temperature is low and below the dew point temperature, Peltier device cooling fan 716 may be deactivated to conserve power. If battery enclosure temperature is higher than the dew point temperature, the Peltier device cooling fan 716 may be activated to increase dehumidification by lowering the temperature of surface 728.

In one example, battery enclosure 700 may include humidity sensor 722 for determining humidity concentration within a battery enclosure and temperature sensor 724 for determining the dew point within battery enclosure 700. Humidity sensor 722 provides an indication of humidity within battery pack 700. The dew point within battery pack 700 can then be determined from a table that relates humidity to dew point. By lowering the temperature of surface 728 below the dew point, water vapor in battery pack 700 may be condensed into water that can be directed outside of battery pack enclosure 700. The routine of FIG. 11 may control current flow to Peltier device 712.

Referring now to FIG. 8, an alternate example of a Peltier humidity control device applied to a battery enclosure is shown. In this example, the warm side of the Peltier device is in communication with coolant circuit 804. Battery pack enclosure 800 includes battery cell stack 802, coolant circuit 804, EDM 806, BCM 808, conductive grease 818, coolant connector 810, humidity sensor 822, and temperature sensor 824. This configuration allows heat generated by the Peltier device to be carried away by coolant circuit 804. Battery pack enclosure 800 includes battery cell stack 802, coolant circuit 804, EDM 806, BCM 808, conductive grease 818, and coolant connector 810.

In one example, current may be passed through Peltier device 812 when humidity in battery enclosure 800 is greater than a threshold. Peltier device 812 is oriented so that condensed water drops onto collector 814 by gravity. Collector 814 directs accumulated water to outside the battery enclosure. A check valve 826 may be placed between collector 814 and ambient air, and check valve 826 may further include a seal such as a hermetic seal. The check valve 826 allows water to pass from the battery enclosure but reduces air flow into the battery enclosure. The routine of FIG. 11 may control current flow to Peltier device 812.

Thus, the systems of FIGS. 7 and 8 provide for a system for controlling humidity of a battery module, comprising: at least one battery cell; an enclosure containing said at least one battery cell; and a Peltier device in communication with said enclosure. The system further comprises a controller for adjusting a current supplied to said Peltier device and a timing of said current is supplied to said Peltier device. The system including wherein said controller includes instructions for supplying said current to said Peltier device when a humidity sensor indicates a humidity concentration in said enclosure higher than a threshold amount. The system further comprises attaching at least a portion of a surface of said Peltier device to a coolant circuit, said coolant circuit located within said enclosure. The system includes wherein said at least one battery cell is a plurality of battery cells. The system further comprises a controller with instructions for operating said Peltier device is excess current produced from balancing charge between said plurality of cells.

Further, the systems of FIGS. 7 and 8 provide for a system for controlling humidity of a battery module, comprising: at least one battery cell; an enclosure containing said at least one battery cell; a Peltier device in communication with said enclosure; and a drain from said Peltier device to a location out of said enclosure. The system includes wherein said drain includes an S-shaped trap. The system includes wherein drain includes a check valve. The system includes wherein said Peltier device is air cooled. The system includes wherein current from said at least one battery cell is coupled to the Peltier device. The system includes wherein a circuit said Peltier device may be periodically activated when said battery is in a sleep mode. The system includes wherein said Peltier device has a cold side mounted such that condensed water falls into a collector by gravity.

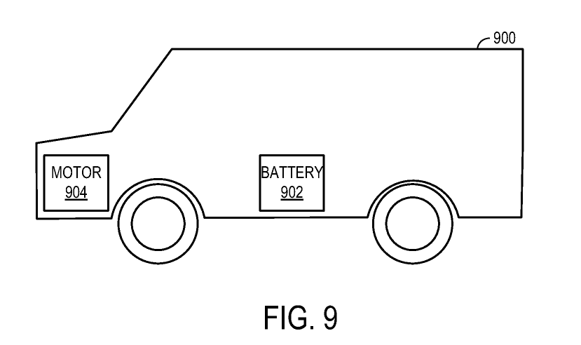

Referring now to FIG. 9, a schematic view of a non-limiting application of the present system and method is shown. In particular, battery pack 902 is installed in a vehicle 900 for the purpose of supplying energy to propel vehicle 900 by way of electric motor 904. In one example, vehicle 900 may be propelled solely by electric motor 904. In another example, vehicle 900 may be a hybrid vehicle that may be propelled by an electric motor and an internal combustion engine.

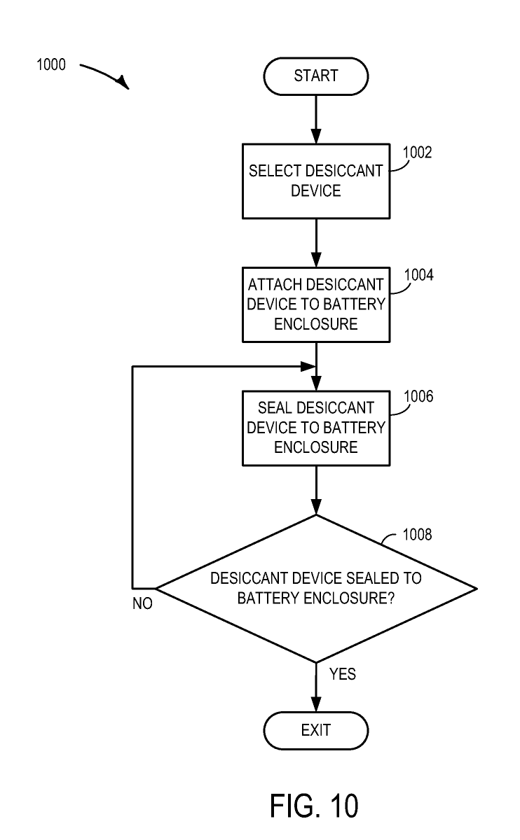

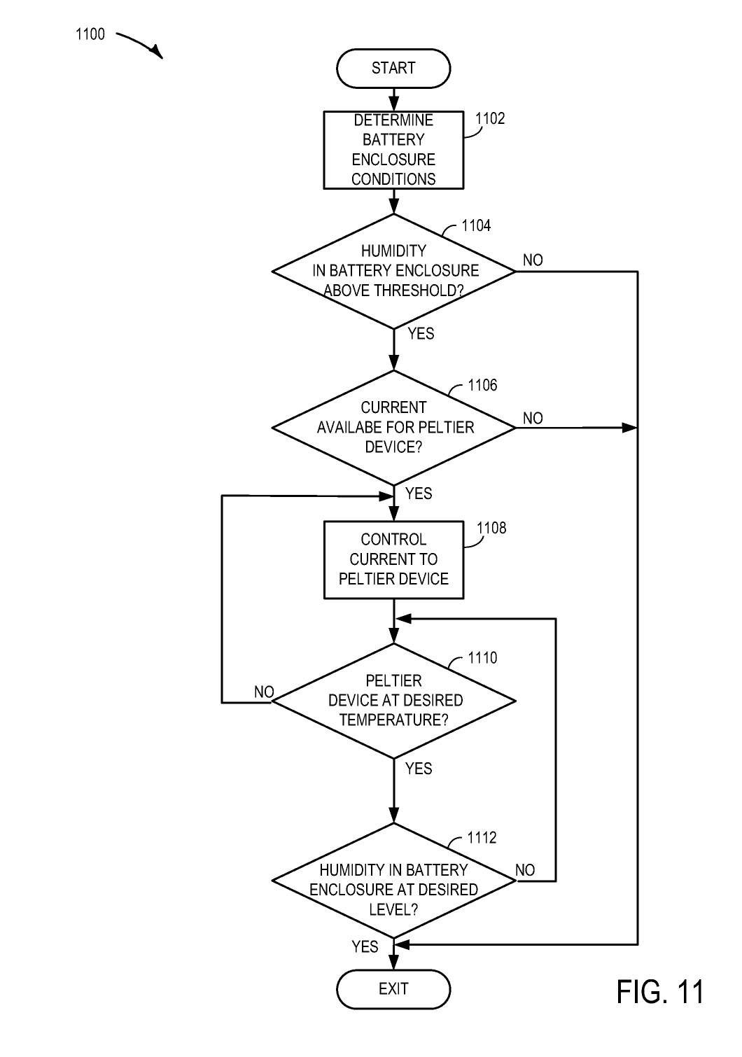

Referring now to FIG. 10, a flowchart of a method for dehumidifying a battery enclosure is shown. In routine 1000 a desiccant device is selected at 1002. The desiccant material may be selected from a variety of known hygroscopic materials including but not limited to clay, silica gel, calcium chloride, and crystalline metal aluminosilicate zeolite. The desiccant may be packaged in a threaded screw on cartridge, a snap-on cartridge, or other known enclosure that holds the desiccant in place and that permits water vapor to flow to the desiccant material.

At 1004, the desiccant device is attached to the battery enclosure. In one example, a desiccant cartridge may be attached to the battery enclosure by screwing the desiccant cartridge onto a threaded post, the post having a hollow interior that permits gas flow from the battery enclosure to the desiccant material. In one example, it is desirable to have a seal between the battery enclosure and the threaded post to reduce the possibility of water ingress into the battery enclosure. Further, it may be desirable in some applications to provide a seal on the desiccant canister such that water ingress to the desiccant material and the battery enclosure is reduced when the desiccant cartridge is attached to the battery enclosure.

In some examples, the desiccant cartridge may be replaced at regular service intervals. For example, the desiccant cartridge may be replaced every 6 months or every 20,000 miles of vehicle usage.

At 1006, the desiccant device is sealed to the battery enclosure. In one application, a desiccant cartridge may be sealed to the battery enclosure by turning the desiccant cartridge by a ¼ turn after the desiccant cartridge has been threaded onto a threaded post and makes snug contact with the exterior of the enclosure.

At 1008, routine 1000 checks if the desiccant device is sealed to the battery enclosure. In some applications, it may be desirable to perform a pressure check to ensure a positive seal between the desiccant cartridge and the battery enclosure. For example, a positive or negative pressure may be applied to the battery enclosure. If the battery enclosure pressure does not rise or fall more than a predetermined amount over a predetermined period of time, it may be judged that there is a positive seal between the desiccant cartridge and the battery enclosure. In other applications it may be desirable to simple tighten the desiccant to the battery enclosure at a prescribed torque. If it is judged that there is not a proper seal between the desiccant cartridge and the battery enclosure, routine 1000 returns to 1006. Once it is judged that the desiccant is sealed to the battery enclosure, routine 1000 ends.

Thus, the method of FIG. 10 provides for a method for removing water vapor from a battery module, comprising: attaching a desiccant device to an exterior of a battery module, hygroscopic material contained in said desiccant device in communication with an interior of said desiccant device; and sealing said desiccant device to said battery module. The method includes wherein said desiccant device is replaced at regular service intervals. The method further comprises removing and replacing said desiccant device in response to a humidity sensor. The method includes where said battery module includes an inclusion, said inclusion capable of enclosing a substantial portion of said desiccant device. The method includes where said desiccant device is a disposable cartridge. The method includes where said battery module is comprised of a plurality of battery cells. The method includes where said desiccant device includes a seal for reducing air flow from atmosphere to inside said battery module.

Referring now to FIG. 11, flow chart of a routine for controlling a Peltier device for dehumidifying a battery enclosure is shown. At 1102, battery enclosure conditions are determined by routine 1100. In one example, a humidity sensor may be placed in the battery enclosure to determine a relative humidity within the battery enclosure. Further, temperature and pressure sensors may be provided, if desired. In one example, the BCM includes instructions for processing data from sensors within the battery enclosure and compares the sensed information against data stored in memory of the BCM.

At 1104, routine 1100 judges whether or not a humidity level in the battery enclosure is greater than a threshold. If a humidity level in the battery enclosure is greater than a threshold, routine 1100 proceeds to 1106. Otherwise, routine 1100 proceeds to exit.

At 1106, routine 1100 judges whether or not current is available to operate the Peltier humidity control device. In one example, the BCM includes instructions for supplying current to the Peltier humidity device when the state of battery charge is greater than a threshold amount. Further, it is possible to include additional instructions for limiting current flow to the Peltier device under other conditions and sub-conditions. For example, current may be applied to the Peltier device when balancing charge between battery pack cells. In one example, the Peltier device may replace passive load resistors for consuming excess charge when balancing battery cells. Further, the Peltier device may be supplied current when the battery is in a sleep mode (e.g., when the battery is not supplying power to an external load). In another example, the Peltier device may be deactivated and may not receive current when the battery is in a sleep mode. Under other conditions, the Peltier device may be supplied current when temperature within the battery enclosure is above a threshold or below a threshold. For example, if temperature in the battery enclosure is below the dew point temperature current may not be supplied to the Peltier humidity control device. In another example, current may not be supplied to the Peltier humidity control device when a temperature in the battery enclosure is greater than a threshold temperature. Thus, the conditions and timing at which current is periodically supplied to the Peltier device can be adjusted in response to operating conditions. In addition, current may be supplied to the Peltier device at predetermined periodic intervals if desired. If it is judged that current is available to the Peltier humidity control device, routine 1100 proceeds to 1108. Otherwise, routine 1100 proceeds to exit.

It should be noted that power for the Peltier device may come from the battery cells internal to the battery pack or from an external source. In some examples, the BCM may choose from which power source the Peltier device receives power.

At 1108, routine 1100 controls current to the Peltier humidity control device. In one example, routine 1100 supplies current to the Peltier humidity control device based on the dew point temperature minus an offset temperature. The offset temperature may be used to drive the Peltier humidity control device below the dew point temperature in order to increase the rate of water separation from the battery enclosure. The dew point temperature may be related to relative humidity through a look-up table, and it is possible to establish the dew point temperature by interrogating a humidity sensor and looking up the dew point temperature. Therefore, once the dew point temperature is established, it can be used to index a table that outputs a current amount as a function of dew point temperature and ambient temperature in the battery enclosure. In this way, an open loop estimate of a desired current to be supplied to the Peltier humidity control device can be made.

In another example, current flow to the Peltier humidity control device may be controlled in a closed loop manner by sensing the temperature of the Peltier humidity control device. In particular, current can be increased to the Peltier humidity control device when the sensed temperature is greater than the dew point temperature. And, current can be decreased to the Peltier humidity control device when the sensed temperature is less than the dew point temperature. After adjusting the current to the Peltier humidity control device, routine 1100 proceeds to 1110.

At 1110, routine 1100 judges whether or not the Peltier humidity control device is at a desired temperature. In one example, a temperature sensor may be proximate to the cold side of the Peltier humidity control device. If the Peltier humidity control device is at the desired temperature routine 1100 proceeds to 1112. Otherwise, routine 1100 returns to 1108.

At 1112, routine 1100 interrogates a humidity sensor to determine the humidity level in the battery enclosure. If the humidity level is greater than a desire amount routine returns to 1110. Otherwise, routine 1100 stops current flow to the Peltier humidity control device and exits.

Thus, the method of FIG. 11 provides for A method for removing moisture from a battery enclosure, comprising: adjusting current to a Peltier device, said Peltier device contained in a battery enclosure; and discharging condensate collected by said Peltier device from said battery enclosure. The method includes wherein said Peltier device is supplied current in response to a humidity sensor located in said enclosure. The method includes wherein said Peltier device is supplied current at predetermined intervals. The method further comprises cooling said Peltier device with coolant. The method includes wherein flow of said coolant is controlled so that a temperature of said Peltier device is within a predetermined range. The method includes wherein said current is supplied by at least one battery cell contained in said enclosure. The method includes wherein said Peltier device may be deactivated when said battery is in a sleep mode. The method includes wherein said adjusting includes periodically supplying current to the Petlier device. The method includes wherein said adjusting is in response to an operating condition of the battery.

The subject matter of the present disclosure includes all novel and nonobvious combinations and subcombinations of the various systems and configurations, and other features, functions, and/or properties disclosed herein.

The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A system for controlling humidity of a battery module, comprising:
at least one battery cell;
an enclosure containing said at least one battery cell; and
a desiccant device, said desiccant device removably attached to said enclosure.

2. The system of claim 1, wherein said enclosure includes an inclusion, said inclusion capable of enclosing a substantial portion of said desiccant.

3. The system of claim 1, wherein said desiccant device is a disposable cartridge.

4. The system of claim 3, wherein cartridge includes a seal for reducing air flow from atmosphere to inside said enclosure or said cartridge.

5. The system of claim 3, wherein a content of said cartridge is exposed to an interior of said enclosure when said cartridge is installed to said enclosure.

6. The system of claim 1, wherein said desiccant device protrudes from said enclosure.

7. The system of claim 3, wherein said disposable cartridge is sized to hold more than 0.1 grams of water.

8. A system for controlling humidity of a battery module, comprising:
at least one battery cell;
a cold plate for removing heat from said at least one battery cell;
a coolant circuit for removing heat from said cold plate and transferring said heat to a radiator of an automobile;
an enclosure containing said at least one battery cell, said cold plate, and said coolant circuit; and
a desiccant device, said desiccant device removably attachable to said enclosure.

9. The system of claim 8, wherein said enclosure includes an inclusion, said inclusion capable of holding a substantial portion of said desiccant device such that a protrusion of said desiccant device from said enclosure is reduced.

10. The system of claim 8, wherein said at least one battery cell is a plurality of battery cells.

11. The system of claim 8, wherein said plurality of battery cells are strapped together.

12. The system of claim 8, further comprising a humidity sensor for indicating when to change said desiccant device.

13. The system of claim 8, wherein said desiccant device includes a hygroscopic material.

14. A method for removing water vapor from a battery module, comprising:
attaching a desiccant device to an exterior of a battery module, hygroscopic material contained in said desiccant device in communication with an interior of said desiccant device; and
sealing said desiccant device to said battery module.

15. The method of claim 14, wherein said desiccant device is replaced at regular service intervals.

16. The method of claim 14, further comprising removing and replacing said desiccant device in response to a humidity sensor.

17. The method of claim 14, where said battery module includes an inclusion, said inclusion capable of enclosing a substantial portion of said desiccant device.

18. The method of claim 17, where said desiccant device is a disposable cartridge.

19. The method of claim 14, where said battery module is comprised of a plurality of battery cells.

20. The method of claim 14, where said desiccant device includes a seal for reducing air flow from atmosphere to inside said battery module.
